(19) United States
(12) Patent Application Publication
(10) Pub. No.: US 2026/0227669 A1
(43) Pub. Date: Aug. 6, 2026

(54) METHOD FOR STEERING LIGHT FOR A PROJECTOR AND LIGHT STEERING PROJECTOR

(71) Applicants: BARCO N.V., Kortrijk (BE); BARCO VISUAL SOLUTIONS, INC., Vancouver (CA)

(72) Inventors: Dries DOORNAERT, Wevelgem (BE); Eric NODWELL, Vancouver (CA)

(73) Assignees: BARCO N.V., Kortrijk (BE); BARCO VISUAL SOLUTIONS, INC., Vancouver, BC (CA)

(21) Appl. No.: 19/152,985

(22) PCT Filed: Feb. 5, 2024
(86) PCT No.: PCT/EP2024/052819

§ 371 Date: Aug. 1, 2025

(30) Foreign Application Priority Data
Feb. 3, 2023 (LU) LU103067

(51) Int. Cl. G02F 1/29; G03B 21/20

(52) U.S. Cl. CPC G02F 1/292; G03B 21/20

(57) ABSTRACT

Efficient light steering systems and methods. An example method for steering light for a projector system includes illuminating an active surface of a light steering module. The active surface of the light steering module may include a plurality of individually controllable pixels. The method may also include determining a target steering phase pattern for each of a plurality of distinct regions of the active surface of the light steering module. The method may also include controlling the light steering module according to the corresponding target steering phase pattern for each region to increase light steering efficiency.

### FIELD

The present disclosure relates to light steering projector systems and methods. Some embodiments provide high efficiency light steering projector systems and methods.

### BACKGROUND

Projector systems modulate beams of light to generate desired images. There are many situations where it is desired to create a light field that has a specified luminance profile. Light projection systems have a very wide range of applications from architectural lighting to the display of lifelike images. The projected light patterns can be dynamic (e.g. video), static (used for static images or static applications like the beams of typical car headlights projected through a lens onto the road, made by arbitrarily shaped optical surfaces, etc.). Light may be projected onto a wide range of screens and other surfaces which may be flat or curved. Such surfaces may be fully reflective (like a canvas projector screen used in a cinema, a wall or a building) or partially reflective (such as the windshield of a vehicle). Screens may be low-gain or high-gain, Lambertian or highly directional, high-contrast or lower in contrast. Light may be projected onto solid objects or onto a medium in a volume (such as fog).

Both light efficiency and dynamic range are major concerns for commercial projector designs. High contrast and peak luminance are vital for higher perceived image quality (brightness, colorfulness), even if most images only require a small amount of localized very bright highlights above their average picture level in order to appear realistic. On the other hand, a projector system should be highly efficient to minimize power consumption, and simplify thermal management. The latter concern makes it impractical to achieve very high peak brightness by boosting the power of a projector light source.

Amplitude spatial light modulators (or SLMs) are often used to create tones and colors in images by pixel-selectively blocking light. Such SLMs tend to be optically inefficient since blocked light is absorbed.

HDR (high dynamic range) image projection may be achieved by providing two or more stages of light modulators. Many light modulators (e.g. LCD panels) generate a desired light field by subtraction (i.e. by absorbing unwanted light). Some efforts have been made to create desired light fields by reallocating light.

There is a general desire for improved projector systems.

### SUMMARY

This invention has a number of aspects. These include, without limitation:
systems and methods which use light steering to project light patterns;
systems and methods for optimizing target light steering patterns.

One or more aspects described herein may be applied to, for example (non-limiting):
cinema projectors;
virtual reality (VR) devices such as VR glasses;
augmented reality (AR) devices such as AR glasses;
head-up displays;
vehicle headlights;
etc.

One aspect of the invention provides a method for steering light for a projector. The method may comprise illuminating an active surface of a light steering module. The active surface of the light steering module may comprise a plurality of individually controllable pixels. The method also comprises dividing the active surface into a plurality of distinct regions. Each region may comprise a corresponding subset of the plurality of individually controllable pixels. The method may also comprise determining a target steering phase pattern for each of a plurality of distinct regions of the active surface of the light steering module. The method may also comprise independently controlling each distinct region of the active surface according to its unique target steering phase pattern to increase light steering efficiency.

A “target steering phase pattern” refers to a specific phase pattern or phase grating applied either across a full spatial phase modulator or within a defined region of it. When appropriately illuminated, this pattern is expected to generate a light field on a designated target plane (such as the surface of a spatial amplitude modulator). The objective is to align this produced light field as closely as possible with a predetermined target light field.

Determining the target steering phase pattern for each region may be based at least in part on a steering efficiency function of the region.

Determining the target steering phase pattern for each region may be based at least in part on a desired target light field.

Determining the target steering phase pattern for each region may comprise performing an optimization.

Performing the optimization may comprise constraining the optimization such that a sum of contributions for all of the regions provides the desired target light field.

Performing the optimization may comprise determining the target steering phase pattern for each region in a way such that each region preferentially contributes more light to locations within the desired target light field for which the steering angle required to steer the light from the region is smaller.

Performing the optimization may comprise optimizing an objective function which, for each region, attributes relatively high cost to target steering phase patterns where the steering angle required to steer the light from the region is relatively large and relatively low cost to target steering phase patterns for where the steering angle required to steer the light from the region is relatively small.

Performing the optimization may comprise constraining the optimization such that each region contributes at least a proportion of light at every location (e.g. discrete point) in the desired target light field.

The advantage of setting optimization constraints, such as requiring every region to contribute at least a certain proportion of light at every point in the target image, lies in ensuring specific characteristics or qualities in the resulting image. Overall, optimization constraints help guide the optimization process towards producing images that meet specific criteria or standards, while also providing flexibility and efficiency in the optimization process.

This additional constraint requires each region to direct some light to every location within the target field. While the method continues to prioritize minimizing steering angles, this added constraint mandates that a portion of light be directed to every target point.

The optimization may comprise an iterative optimization.

Performing the optimization may comprise estimating an actual light field output from the light steering module when particular target steering phase patterns are applied to respective regions of the light steering module.

The actual light field may be estimated based on:

$$B ( x , y ) = {\sum }_{b = 1}^{b = N} {S}_{b} ( x , y ) {P}_{b} ( x , y )$$

where x and y represent a location in the light field, B(x,y) is the estimated actual light field, b is an index that runs over all N regions, S_{b}(x,y) represents steering efficiency of region b for steering light to point (x, y) in the actual light field and P_{b}(x,y) is a predicted contribution to the actual light field from region b without correction for steering efficiency.

The method may also comprise estimating S_{b}(x,y) with a sum of basis functions.

S_{b}(x,y) may comprise a smooth slowly-varying function when compared to a size of a point spread associated with the projector.

Performing the optimization may comprise compensating for one or more defocusing effects associated with the projector using one or more point spread functions (PSFs).

Compensating for the one or more defocusing effects may comprise negating effective convolution with the one or more PSFs.

Compensation for the one or more defocusing effects may comprise effecting a deconvolving procedure based on the one or more PSFs.

Compensating for the one or more defocusing effects may comprise at least partially accounting for physical limitations of the projector.

Performing the optimization may comprise estimating a deconvolved actual light field output from the light steering module when particular target steering phase patterns are applied to respective regions of the light steering module.

The deconvolved actual output light field R(x,y) may be determined based on:

$$R ( x , y ) = {\sum }_{b = 1}^{b = N} {S}_{b} ( x , y ) {T}_{b} ( x , y )$$

where x and y represent a position in the deconvolved actual output light field, b is an index that runs over all N regions, S_{b}(x,y) represents steering efficiency of region b for steering light to point (x, y) in the deconvolved actual output light field and T_{b}(x,y) represents a deconvolved steering target (i.e. a light field corresponding to a contribution) for a region b.

T_{b}(x,y) may be determined based on:

$${T}_{b} ( x , y ) = \frac{{K}_{b} {S}_{b}^{β - 1} ( x , y )}{{\sum }_{a} {K}_{a} {S}_{a}^{β} ( x , y )} R ( x , y )$$

where a is an index over the N regions and K₁, K₂, . . . , K_{N} are constants to be determined by the optimization.

Performing the optimization may comprise constraining each region to have an equal amount (e.g. power) of available incident light.

The method may also comprise providing each region with an equal amount (e.g. power) of available incident light.

The method may also comprise adjusting provision of incident light for each region based on availability of incident light.

The method may also comprise verifying whether one or more of the target phase patterns are within one or more system capabilities of the projector.

The method may also comprise adjusting at least one of the target steering phase patterns based on the one or more system capabilities of the projector.

Another aspect of the invention provides a light steering projector. The light steering projector may comprise a light steering module having an active surface. The active surface of the light steering module may comprise a plurality of individually controllable pixels. The light steering projector may also comprise at least one spatial light modulator configured to spatially modulate light from the light steering module. The light steering module may also comprise a projector system configured to project the spatially modulated light. The light steering module may also comprise a controller. The controller may be configured to divide the active surface into a plurality of distinct regions, each region comprising a corresponding subset of the plurality of individually controllable pixels. The controller may also be configured to determine a target steering phase pattern for each of a plurality of distinct regions of the active surface of the light steering module. Each region may comprise a corresponding subset of the plurality of individually controllable pixels. The controller may also be configured to control the light steering module according to the corresponding target steering phase pattern for each region to increase light steering efficiency. The controller may also be configured to independently control each distinct region of the active surface according to its unique target steering phase pattern to increase light steering efficiency.

The light steering projector may be configured to carry out a method having any feature or combinations of features described herein.

Another aspect of the invention provides a data processing apparatus comprising means for carrying out a method having any feature or combinations of features described herein.

Another aspect of the invention provides a computer program product comprising instructions which, when the program is executed by a computer, cause the computer to carry out a method having any feature or combinations of features described herein.

Another aspect of the invention provides a computer-readable medium having stored thereon a computer program product as described herein.

Further aspects and example embodiments are illustrated in the accompanying drawings and/or described in the following description.

It is emphasized that the invention relates to all combinations of the above features, even if these are recited in different claims.

### BRIEF DESCRIPTION OF THE DRAWINGS

The accompanying drawings illustrate non-limiting example embodiments of the invention.

FIG. 1 is a schematic illustration of an example optical path.

FIG. 2 is a schematic illustration of an example active surface of a phase modulator of a light steering module.

FIG. 3 is a block diagram illustrating a method according to an example embodiment of the invention.

FIG. 3A is a block diagram illustrating a method according to an example embodiment of the invention.

FIG. 4 is a schematic illustration of an example architecture of a light projecting system.

FIG. 5 is a graph illustrating the steering efficiencies of phase modulators plotted along the horizontal center line of the screen.

FIG. 6 is a graph illustrating the steering efficiencies for two real phase modulators and for 4 virtual phase modulators (for a single primary), wherein the thicker lines show the maximum in each case.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

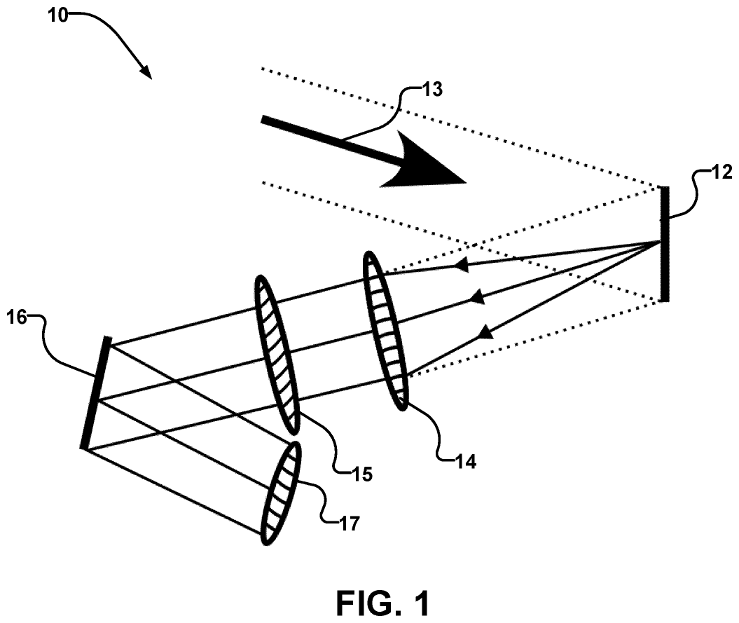

FIG. 1 is a schematic illustration of an example optical path 10 of a light projecting system which may project images onto a screen or other surface. In some embodiments, the light projecting system comprises a High Dynamic Range (HDR) projector. In some embodiments the HDR projector comprises a projector having a contrast ratio that is greater than about 1/2000. In some embodiments the HDR projector has a contrast ratio that is about 1/5000. In some embodiments the HDR projector has a contrast ratio that is about 1/60000. In some embodiments the HDR projector has luminance in the range from about 5 millinits to about 300 nits.

Example optical path 10 comprises at least one light steering module 12 which may be illuminated by incoming light 13. Light steering module 12 steers incoming light 13 to generate a desired light pattern in an image plane. Optionally, one or more downstream lenses (e.g. lenses 14 and 15) or other optical elements (e.g. mirrors, etc.) are arranged to capture the steered light and focus it onto at least one spatial light modulator (SLM) 16 (e.g. at least one amplitude light modulator such as a digital micromirror device (DMD), a Liquid Crystal on Silicon (LCoS) spatial light modulator, etc.). SLM 16 typically comprises an amplitude spatial light modulator. A projection lens 17 (or projector system) may collect and project the spatially modulated light onto a screen (not shown).

Light steering module 12 is controllable to steer light incoming light 13 which is incident on light steering module 12. In some embodiments light steering module 12 comprises one or more phase modulators. The one or more phase modulators may each comprise a plurality of individually controllable pixels which are each operable to vary the phase of incident light. The pixels of the phase modulator may be arranged in a two-dimensional array.

In some embodiments light steering module 12 comprises one or more Liquid Crystal on Silicon (LCoS) phase modulators. In some embodiments light steering module 12 comprises one or more microelectromechanical system (MEMS) phase modulators.

By controlling pixels of the phase modulator to apply a pattern of phase shifts to the incident light, the incident light may be steered as desired. A phase pattern may be generated by processing image data which directly or indirectly specifies luminance or relative light intensity as a function of position in an image to be projected. Each phase modulator (or the pixels of each phase modulator) may be controlled to steer light according to a phase pattern to steer incident light to create a light field in which light has a desired distribution of light intensity as a function of position. In some embodiments light is steered (e.g. by light steering module 12) as described in WO2015054797 titled LIGHT FIELD PROJECTORS AND METHODS.

Incoming light 13 comprises light of a primary colour (e.g. red light, green light, blue light). Incoming light 13 may be coherent light. Incoming light 13 may, for example, comprise light emitted from one or more laser light sources.

In some embodiments a projector system comprises a plurality of optical paths 10. Each optical path 10 may correspond to a primary colour of light (e.g. at least one optical path 10 and light steering module 12 for red light, at least one optical path 10 and light steering module 12 for green light and at least one optical path 10 and light steering module 12 for blue light). In some embodiments incoming light 13 cycles between the primary colours (e.g. red then green then blue then back to red then green then blue . . . ). In some such embodiments optical path 10 may comprise a single light steering module 12.

Phase modulators typically exhibit a decrease in light steering efficiency as a function of steering angle (i.e. the difference between the angle at which the steered light is directed and the angle at which the light would be directed with no steering (e.g. when light steering module 12 is set according to a uniform phase pattern)). Specifically, as steering angle increases the light steering efficiency typically decreases. By dividing an active surface of a phase modulator into a plurality of regions and independently controlling each of the regions to display its own phase patterns to steer incident light, the overall efficiency with which incident light 13 is delivered to a screen may be increased. This may be done by selecting a portion of the desired output light to be steered by each of the regions in such a way that steering angles tend to be smaller, thereby increasing overall light steering efficiency. For example, in some cases dividing the active surface of the phase modulator may reduce the amount of light that is steered through larger steering angles and/or reduce a maximum steering angle that is used.

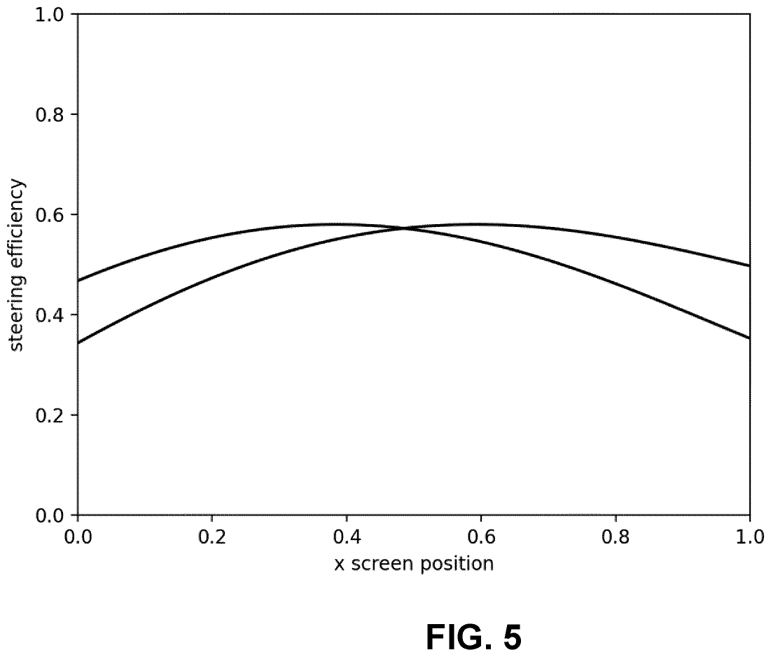

The steering efficiency can be measured experimentally to derive steering efficiency functions, particularly for normal, undivided steering conditions. These functions, depicted in FIG. 5, can be obtained through a camera-based calibration process. Notably, the analysis reveals that steering effectiveness is not solely optimized when directed “directly ahead” due to the pre-tilt characteristics of phase modulators. The asymmetry in steering efficiencies resulting from opposing pre-tilts of phase modulators presents an opportunity to enhance steering effectiveness. By leveraging this asymmetry, the method introduces divided panel steering, expanding the repertoire of unique steering efficiency functions from two to more.

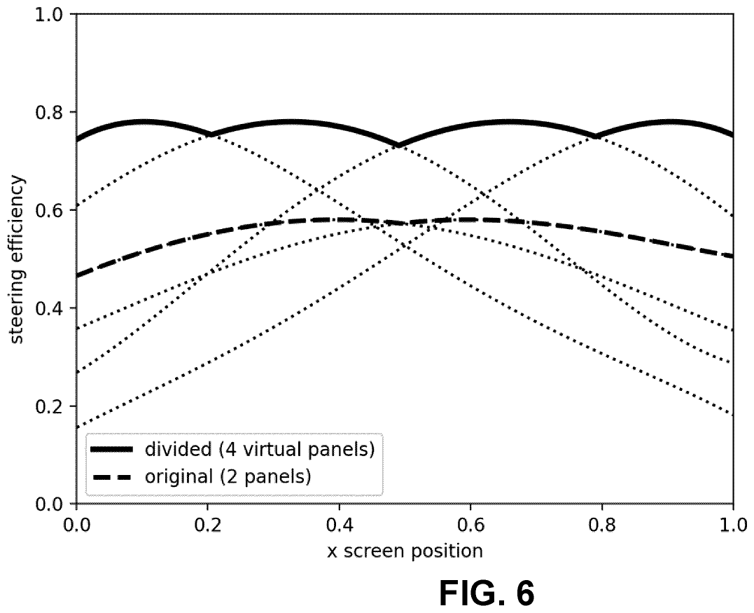

In FIG. 6, divided panel steering serves as a method to expand the capability from two to four unique steering efficiency functions, which can be blended to optimize the overall “average” steering efficiency. FIG. 6 illustrates this concept, showcasing the four steering efficiency functions derived from four virtual phase modulators utilized in divided panel steering. Notably, these functions exhibit maxima at distinct positions across the screen, a result of the pre-tilt characteristics inherent in the phase modulators. Remarkably, the pre-tilt contributes to generating four maxima, doubling the capacity compared to traditional steering methods. Furthermore, these maxima are evenly spaced across the screen, enhancing the versatility of steering options. The bold line depicted in the figure represents the maximum value attained from the four steering efficiency functions, significantly surpassing the maximum achievable with only two steering efficiency functions from real phase modulators. When hypothetically a frame necessitates precisely positioned highlights aligned with these four maxima could achieve optimal results by steering one virtual panel for each highlight.

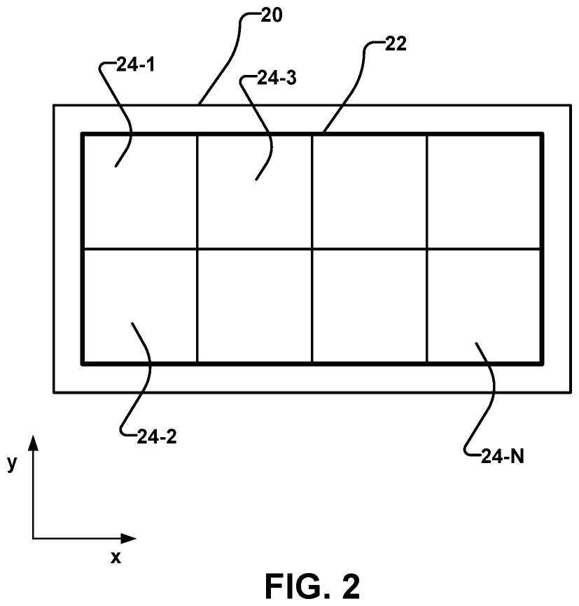

An active surface of a phase modulator may be divided into two or more regions. In general, an active surface 22 of a phase modulator 20 of light steering module 12 may be divided into a plurality of N regions with N being any suitable number where N≥2. FIG. 2 shows regions 24-1, 24-2, 24-3, . . . , 24-N, collectively or generally regions 24. In some embodiments each region 24 is the same size (i.e. each region has the same surface area and/or number of pixels). However, this is not necessary in all cases. In some embodiments a first region 24 is larger than a second region 24 (i.e. the first region has a larger surface area than the second region). Additionally, two regions 24 may have the same or different shapes.

In some embodiments the number of regions or characteristics of one or more of the regions (e.g. boundaries, size, shape, etc.) are varied dynamically in real time.

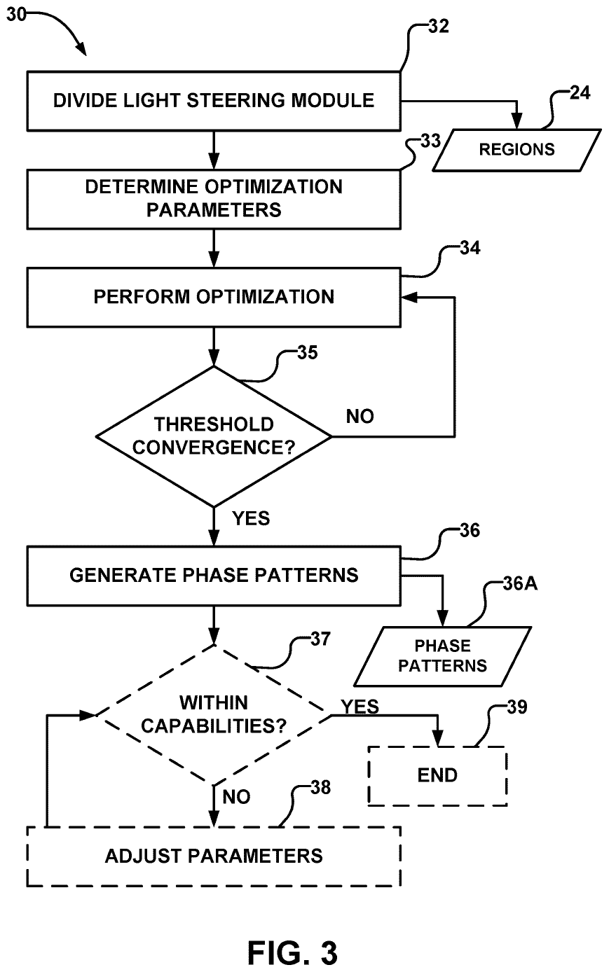

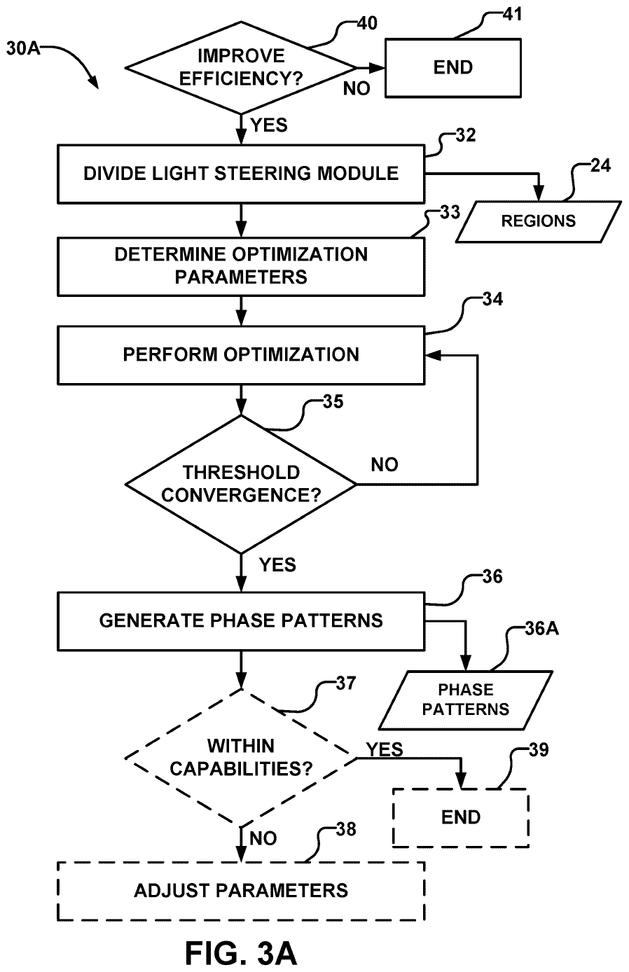

FIG. 3 is a block diagram illustrating an example method 30 for optimizing steering efficiency of a light steering module 12. In some embodiments method 30 is performed for each primary colour of light.

In block 32 an active surface of a light steering module (or phase modulator(s)) 12 is divided (e.g. logically divided) into a plurality of regions (e.g. two regions) 24. As described elsewhere herein, pixels within each of the regions 24 may be individually controllable to display a desired phase pattern to steer incident light accordingly.

In some embodiments the active surface of a light steering module 12 is divided into 16 or fewer regions (e.g. 2 regions) 24. In some embodiments the active surface of the light steering module 12 is divided into 2 to 10 regions 24. In some embodiments the number of regions 24 into which the active surface of light steering module 12 is divided may at least be based on a trade-off or comparison between an increase in computational demand to have more regions 24 versus an increase in light steering efficiency by having more regions 24. In some embodiments the number of regions 24 into which the active surface of light steering module 12 is divided is based on a desire to have logical correspondence between a layout of the active surface and light steering functions.

For example, a phase pattern displayed by a light steering module 12 which comprises square pixels will generate a square lightfield. The square lightfield may be repeated periodically (e.g. due to higher order diffractions). In some embodiments a phase pattern to be displayed is selected such that part of the generated lightfield is black while the repetitions of the lightfield remain square. In some embodiments it is computationally logical to match a square end result of the lightfield with a square source. A square source may, for example, be provided by dividing light steering module 12 into square regions. In some embodiments, light steering module 12 may have an approximate size of ~2000×4000 pixels in which case, dividing light steering module 12 into 2 square regions of ~2000×2000 pixels or into 8 square regions of ~1000×1000 pixels may be desirable.

In block 33 optimization parameters are determined. The optimization performed in method 30 determines a contribution to a target light field that is to be delivered by steering light in each of the block 32 regions 24. The method 30 optimization attempts to select the contributions from each of the regions 24 such that:
the sum of the contributions for all of the regions 24 provides the target light field;
the contribution for each of the regions 24 is selected in a way such that each region 24 preferentially contributes more light to locations within the target light pattern for which the steering angle desired to steer the light from the region 24 is smaller.

Since the steering angle desired to steer light to a point in the target light pattern can be different for different regions 24, there is the possibility of improving overall efficiency with which light is delivered to the target light pattern by optimizing the contributions to be made by each of the regions 24 in a way that overall reduces light steering angles and increases light steering efficiency.

In some embodiments, optimization constraints may be set in block 33. The optimization constraints may, for example, require that every region contributes at least a certain proportion of light at every point in the target image. In some embodiments, the block 33 optimization constraints may be set as hard constraints (e.g. conditions that must be satisfied by the method 30 optimization). In some embodiments, the block 33 optimization constraints may be set as soft constraints (e.g. where the constraints take the form of suitably constructed terms in an objective function). If a new target image (e.g. for a new frame) is the same as the previous target image for the previous frame, then the optimized solution for the previous target image may be used for the new target image and a new optimization need not be performed.

In block 34 the optimization is performed. The optimization may be an iterative optimization which repeats a procedure for refining the allocations of contributions to the respective regions 24 a number of times (e.g. 6 times or until some other termination criterion is satisfied). The overall steering efficiency of any allocation of contributions among the individual regions 24 may be determined and used as an indicator of whether additional iterations should be performed (e.g. as a termination condition for the block 34 iterative optimization), whether a sufficient light steering efficiency has been achieved, etc. Block 35 may determine whether the block 34 optimization has converged sufficiently to an optimized allocation of contributions. In some embodiments the block 34 optimization has “converged sufficiently” (or been “maximized” or “minimized”) if an output of the optimization does not vary by more than a configurable threshold amount (e.g. less than 0.5%, 1%, 2%, 5%, etc.). For example, the block 34 optimization may converge sufficiently if an output average light steering efficiency weighted over a target light steering efficiency and/or an actual contribution from each region 24 does not vary by more than a configurable threshold amount in each successive iteration. In some embodiments the optimization has “converged sufficiently” (or been “maximized” or “minimized”) if one or more inputs of the block 34 optimization do not vary by more than a configurable threshold amount in each successive iteration. In some embodiments, the block 35 convergence criteria may comprise a configurable threshold number of iterations of the block 34 optimization. If the block 34 optimization has not converged sufficiently, method 30 returns to block 34 to perform another cycle of the optimization. Otherwise method 30 proceeds to block 36.

Phase patterns 36A to be displayed by corresponding regions 24 of the light steering module 12 may be generated in block 36 by treating the optimized contribution for each region 24 as a target light pattern for the region. In some embodiments the per-region generated phase patterns 36A are stored in, for example, a data store (e.g. data store 55 described elsewhere herein). In some embodiments per-region phase patterns 36A may be combined to generate, for example, control input data for light steering module 12 and such data may be applied to control light steering module 12.

Optional block 37 verifies whether the optimized results (e.g. phase patterns 36A) fall within capabilities of a particular projection system being used. For example, block 37 may verify whether the light projection system is capable of providing the optimized amount of light (e.g. in accordance with phase patterns 36A). If the optimized results do not fall within the capabilities of the projection system, method 30 may proceed to block 38 where the optimized results (and/or generated phase patterns 36A) are adjusted based on the capabilities of the projection system. Otherwise method 30 proceeds to block 39 and terminates. In some embodiments, in addition to or in the alternative to block 37, the capabilities of a particular projection system being used may be incorporated as constraints into the block 34/35 optimization process.

FIG. 3A is a block diagram illustrating an example method 30A for optimizing steering efficiency of a light steering module.

Method 30A is the same as method 30 except that method 30A comprises block 40. Block 40 determines whether or not it is necessary or desirable to perform an optimization as described herein for a particular target light field. For example, block 40 may determine whether to perform an optimization as described above based on a maximum intensity of light corresponding to highlights of an image to be displayed and/or an overall amount of light desired to provide highlights having an intensity over a given threshold in the image to be displayed. If block 40 determines that optimization is not required or not desired, then method 30A may terminate in block 41 and a phase pattern for the entire phase modulator 12 may be generated and applied. Otherwise method 30A proceeds to block 32.

In some embodiments light steering efficiency is determined (e.g. as part of the block 40 inquiry and/or otherwise in the performance of method 30 or 30A) based on a detailed physics-based model of the light projection system. The model may, for example, comprise parameters such as finite pixel size of light steering module (phase modulator(s)) 12, parameters characterizing one or more optical components of the system, etc. In some embodiments light steering efficiency is determined experimentally. For example, light steering efficiency may be determined experimentally with a camera-based or photodiode-based calibration procedure.

In one example case an estimate of the actual light field that will be produced when particular phase patterns 36A are applied to respective regions 24 of a phase modulator that takes into account steering efficiency of the phase modulator of light steering module 12 is calculated as follows:

$$B ( x , y ) = {\sum }_{b = 1}^{b = N} {S}_{b} ( x , y ) {P}_{b} ( x , y ) \qquad ( 1 )$$

where x and y represent a position in the output light field, B(x,y) is the estimated output light field, b is an index that runs over all N regions, S_{b}(x,y) represents steering efficiency of region b for steering light to point (x, y) in the output light field, and P_{b}(x,y) is the predicted contribution to the output light field from region b without correction for steering efficiency. P_{b}(x,y) may be determined from a predicted image at infinity of the phase pattern applied to region b (e.g. via a Fourier transform) followed by a convolution with a point spread function (PSF).

This equation (1) example case does not take into account any unsteerable light (e.g. light that cannot be steered by the phase modulator of light steering module 12) or any base light (e.g. unsteered light that is added to steered light). For example, the unsteerable light and/or the base light may have been previously subtracted. Typically, S_{b}(x,y) are smooth slowly-varying functions compared with the size of the PSF. In some cases S_{b}(x,y) is approximated by a sum of basis functions (e.g. sine and cosine functions, polynomials, etc.).

Real optical systems and/or light sources may have a limited ability to resolve points and/or to focus light to a point source. At least one (but typically many) of the effects which limit the ability of an optical system or light source to resolve points and/or focus light to a point source may be mathematically described (or encapsulated) with one or more point spread functions (PSFs). The one or more PSFs may be convolved with one or more ideal system images to estimate one or more real system images.

In light steering systems, one or more PSFs may be large. It may, for example, be desirable to computationally pre-compensate for a defocusing effect of the one or more PSFs. The pre-compensation may, for example, cancel out any effective convolution (e.g. a physical rather than a computational effect) with the one or more PSFs. To pre-compensate, R(x,y) and T_{b}(x, y) which are deconvolved versions of B(x,y) and P_{b}(x,y) respectively may be used. Because R(x,y) and T_{b}(x, y) are deconvolved (pre-compensated for the PSF effect), driving a system described herein (e.g. light steering modules 12) based on R(x,y) and T_{b}(x, y) may advantageously produce a light field that is substantially close to (or identical to) B(x,y).

In some embodiments the deconvolution accounts for physical limitations. For example the deconvolution may account for the fact that light fields may only have positive values.

Deconvolved output light field R(x,y) (not including any base and/or unsteered light) may be represented as follows:

$$R ( x , y ) = {\sum }_{b = 1}^{b = N} {S}_{b} ( x , y ) {T}_{b} ( x , y ) \qquad ( 2 )$$

where T_{b}(x,y) represents the deconvolved steering target (i.e. a light field corresponding to a contribution) for a region b.

Given R(x,y) and known steering efficiency functions S_{b}(x,y) for each of the regions (b=1, . . . , N) a steering target (or “contribution”) T_{b}(x, y) for each region b may be chosen such that the average of the effective steering efficiency over the desired output light field R(x,y) is maximized subject to the requirement that the sum of S_{b}(x,y) T_{b}(x,y) over b at each (x,y) is R(x,y) (this requirement can be called “constraint 1” and can be stated in words as: the steered light from all of the N regions collectively produces the desired output light field).

In this example it is assumed that the intensity of light incident on the phase modulator of light steering modulator 12 is uniform. That, is, each region b may receive 1/N of the available incident light. Typically the incident light is close to being uniform. If deviations from uniformity of the incident light are significant enough to be concerned with, then such deviations may be absorbed in measured steering efficiency functions or the calculation may explicitly take into account the intensity of incident light as a function of position on the phase modulator. In some cases, a region (or multiple regions) b may get no (i.e. zero) incident light.

As discussed elsewhere incoming light 13 may comprise light of different primary colours. A set of optimized steering targets may be selected for each primary colour based on Equation (2).

At this point in the determination, an amount of light available is preferably not fixed. Rather, how much light is desired is determined and during downstream processing the determined amount may be compared to how much light is actually available. Based on the comparison, appropriate actions may be taken (e.g. to clip some pixels, to over-steer light, to steer some light off-screen, etc.). Such actions may for example be performed as part of optional block 38 described elsewhere herein.

By way of non-limiting example, if it is determined that more light is available than is desired, then:
output light field B(x,y) may be scaled up (e.g. on screen).
a portion of the excess light may be dumped. Dumping a portion of the excess light may advantageously decrease black levels (e.g. make dark portions appear darker), thereby increasing an effective contrast ratio of the system. In some embodiments a portion of the light is dumped using an aperture that can absorb the light (and associated heat load).
Etc.

In some embodiments, for a region b, T_{b}(x, y) is assumed to have the form:

$${T}_{b} ( x , y ) = \frac{{K}_{b} {S}_{b}^{β - 1} ( x , y )}{{\sum }_{a} {K}_{a} {S}_{a}^{β} ( x , y )} R ( x , y ) \qquad ( 3 )$$

Where: a is an index over the N regions; and K₁, K₂, . . . , K_{N} are constants to be determined by the optimization (e.g. the optimization of methods 30, 30A), and β is an exponent such that ≥1. In such embodiments the optimization comprises selecting values for K₁, K₂, . . . , K which yield the best overall steering efficiency. Equation (3) may have the following characteristics:
T_{b}(x,y) is positively correlated with S_{b}(x,y) (i.e. each region is preferably controlled to steer light to locations in the output light field for which the region has higher steering efficiency). The strength of this attraction is set by the parameter B: larger values of β will favour more perfect solutions but at the cost of making solutions harder to find.
Constraint 1 is automatically satisfied when the contribution for each region b is defined by Equation (3).
The contributions (e.g. T_{b}(x, y)) from each region b may be adjusted so that each contribution involves the same total amount of light (“constraint 2”) by making a suitable selection of values for the set of constants K₁, K₂, . . . , K_{N}.

Total power l_{b} of light incident on a region b may, for example, be represented as follows:

$${I}_{b} = \int {T}_{b} ( x , y ) dxdy . \qquad ( 4 )$$

Constraint 2 may, for example, be represented as follows:

$${I}_{b} = \frac{1}{N} {\sum }_{a} {I}_{a} . \qquad ( 5 )$$

Equations (2) to (5) (e.g. four equations with four unknowns) may be solved, for example, iteratively.

For example, l_{b} may be factored into:

$${I}_{b} = {K}_{b} {G}_{b} \qquad ( 6 )$$

$$where :$$

$${G}_{b} = \int \frac{{S}_{b}^{β - 1} ( x , y )}{{\sum }_{a} {K}_{a} {S}_{a}^{β} ( x , y )} R ( x , y ) dxdy . \qquad ( 7 )$$

From there:

$${K}_{b} {G}_{b} = \frac{1}{N} {\sum }_{a} {K}_{a} {G}_{a} . \qquad ( 8 )$$

The iterative solution may, for example, be represented as follows:

$${K}_{b}^{( i + 1 )} = \frac{1}{N {G}_{b}^{( i )}} {\sum }_{a} {K}_{a}^{( i )} {G}_{a}^{( i )} \qquad ( 9 )$$

where: i is an iteration index; and

$${G}_{b}^{( i )}$$

are given by equation (7) using

$${K}_{a}^{( i )} .$$

The computational expense may, for example, be principally made up by the computational expense of evaluating the integrals of Equation (7) (e.g. one per region per iteration). Initially, for example, constants K₁, K₂, . . . , K_{N} may be set as follows:

$${K}_{1}^{( 0 )} = {K}_{2}^{( 0 )} = {K}_{3}^{( 0 )} = … = {K}_{N}^{( 0 )} = 1 .$$

In some embodiments, a convergence parameter f may be introduced. The convergence parameter f may, for example, allow for a trade off or optimization between stability (e.g. by selecting a small f) and speed of convergence (e.g. by selecting a large f). An iterative solution with convergence parameter f may, for example, be represented as follows:

$${K}_{b}^{( i + 1 )} = ( 1 - f ) {K}_{b}^{( i )} + \frac{f}{N {G}_{b}^{( i )}} {\sum }_{a} {K}_{a}^{( i )} {G}_{a}^{( i )} \qquad ( 10 )$$

In some cases β=8. In some cases convergence parameter f=1. In some cases 6 iterations are performed. In some cases B is in a range from 1 to 10. In some cases convergence parameter f is less than or equal to 2. In some cases convergence parameter f is in a range from 0.5 to 1. In some cases a number of iterations that are performed is in a range from 1 to 10.

In some embodiments equation (3) is replaced with the following:

$${T}_{b} ( x , y ) = \frac{{K}_{b} {e}^{β {S}_{b} ( x , y )}}{{\sum }_{a} {K}_{a} {S}_{a} ( x , y ) {e}^{β {S}_{a} ( x , y )}} R ( x , y ) . \qquad ( 11 )$$

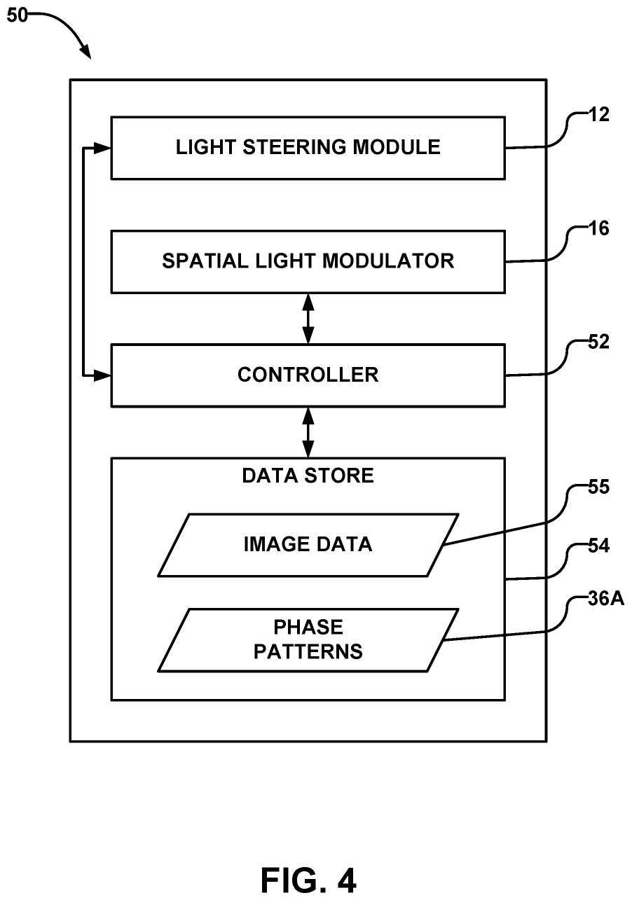

FIG. 4 illustrates an example architecture of a light projecting system 50. Controller 52 controls light steering module 12 and spatial light modulator 16. Data store 54 may store image data 55 to be displayed by light projecting system 50. In some embodiments image data 55 is processed dynamically (e.g. by controller 52) to generate phase patterns (e.g. phase patterns 36A) for light steering module 12. In some embodiments image data 55 is at least partially pre-processed (i.e. prior to the display of a motion picture, etc.) to generate phase patterns (e.g. phase patterns 36A) for light steering module 12. In some embodiments generated phase patterns 36A are stored in data store 54.

In some embodiments controller 52 combines phase patterns (e.g. phase patterns 36A) corresponding to regions 24 into one or more phase patterns which correspond to an entire active surface of light steering module 12 (or the phase modulator(s)). In some embodiments a phase pattern for a region 24 comprises a plurality of phase patterns which have been combined. In some embodiments each of the plurality of phase patterns for the region 24 is identical to the other ones of the plurality of phase patterns.

It is not necessary that all of the regions (e.g. regions 24 and/or regions b described herein) are on the same phase modulator or the same light steering module. Some projectors may include two or more phase modulators or light steering modules for each color channel. Including two or more phase modulators can be desired to reduce the power of light that is steered by each phase modulator, especially where high output power is desired. The methods described above may be applied to improve light steering efficiency where plural regions are distributed across two or more phase modulators or light steering modules.

Where a component (e.g. a software module, processor, assembly, device, circuit, etc.) is referred to herein, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Embodiments of the invention may be implemented using specifically designed hardware, configurable hardware, programmable data processors configured by the provision of software (which may optionally comprise “firmware”) capable of executing on the data processors, special purpose computers or data processors that are specifically programmed, configured, or constructed to perform one or more steps in a method as explained in detail herein and/or combinations of two or more of these. Examples of specifically designed hardware are: logic circuits, application-specific integrated circuits (“ASICs”), large scale integrated circuits (“LSIs”), very large scale integrated circuits (“VLSIs”), and the like. Examples of configurable hardware are: one or more programmable logic devices such as programmable array logic (“PALs”), programmable logic arrays (“PLAs”), and field programmable gate arrays (“FPGAs”). Examples of programmable data processors are: microprocessors, digital signal processors (“DSPs”), embedded processors, graphics processors, math co-processors, general purpose computers, server computers, cloud computers, mainframe computers, computer workstations, and the like. For example, one or more data processors in a control circuit for a device may implement methods as described herein by executing software instructions in a program memory accessible to the processors.

Processing may be centralized or distributed. Where processing is distributed, information including software and/or data may be kept centrally or distributed. Such information may be exchanged between different functional units by way of a communications network, such as a Local Area Network (LAN), Wide Area Network (WAN), or the Internet, wired or wireless data links, electromagnetic signals, or other data communication channel.

The invention may also be at least partially provided in the form of a program product. The program product may comprise any non-transitory medium which carries a set of computer-readable instructions which, when executed by a data processor, cause the data processor to execute a method of the invention. Program products according to the invention may be in any of a wide variety of forms. The program product may comprise, for example, non-transitory media such as magnetic data storage media including hard disk drives, optical data storage media including CD ROMs, DVDs, electronic data storage media including ROMs, flash RAM, EPROMS, hardwired or preprogrammed chips (e.g., EEPROM semiconductor chips), nanotechnology memory, or the like. The computer-readable signals on the program product may optionally be compressed or encrypted.

In some embodiments, the invention may be implemented at least partially in software. The software may, for example, be run on commercially available graphical processor units (GPUs). For greater clarity, “software” includes any instructions executed on a processor, and may include (but is not limited to) firmware, resident software, microcode, code for configuring a configurable logic circuit, applications, apps, and the like. Both processing hardware and software may be centralized or distributed (or a combination thereof), in whole or in part, as known to those skilled in the art. For example, software and other modules may be accessible via local memory, via a network, via a browser or other application in a distributed computing context, or via other means suitable for the purposes described above.

Software and other modules may reside on servers, workstations, personal computers, tablet computers, and other devices suitable for the purposes described herein.

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms. These terms (“a”, “an”, and “the”) mean one or more unless stated otherwise;
“and/or” is used to indicate one or both stated cases may occur, for example A and/or B includes both (A and B) and (A or B);
“approximately” when applied to a numerical value means the numerical value ±10%;
where a feature is described as being “optional” or “optionally” present or described as being present “in some embodiments” it is intended that the present disclosure encompasses embodiments where that feature is present and other embodiments where that feature is not necessarily present and other embodiments where that feature is excluded. Further, where any combination of features is described in this application this statement is intended to serve as antecedent basis for the use of exclusive terminology such as “solely,” “only” and the like in relation to the combination of features as well as the use of “negative” limitation(s)” to exclude the presence of other features; and
“first” and “second” are used for descriptive purposes and cannot be understood as indicating or implying relative importance or indicating the number of indicated technical features.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Where a range for a value is stated, the stated range includes all sub-ranges of the range. It is intended that the statement of a range supports the value being at an endpoint of the range as well as at any intervening value to the tenth of the unit of the lower limit of the range, as well as any subrange or sets of sub ranges of the range unless the context clearly dictates otherwise or any portion(s) of the stated range is specifically excluded. Where the stated range includes one or both endpoints of the range, ranges excluding either or both of those included endpoints are also included in the invention.

Certain numerical values described herein are preceded by “about”. In this context, “about” provides literal support for the exact numerical value that it precedes, the exact numerical value ±5%, as well as all other numerical values that are near to or approximately equal to that numerical value. Unless otherwise indicated a particular numerical value is included in “about” a specifically recited numerical value where the particular numerical value provides the substantial equivalent of the specifically recited numerical value in the context in which the specifically recited numerical value is presented. For example, a statement that something has the numerical value of “about 10” is to be interpreted as: the set of statements:
in some embodiments the numerical value is 10;
in some embodiments the numerical value is in the range of 9.5 to 10.5;
and if from the context the person of ordinary skill in the art would understand that values within a certain range are substantially equivalent to 10 because the values with the range would be understood to provide substantially the same result as the value 10 then “about 10” also includes:
   in some embodiments the numerical value is in the range of C to D where C and D are respectively lower and upper endpoints of the range that encompasses all of those values that provide a substantial equivalent to the value 10.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

As will be apparent to those of skill in the art upon reading this disclosure, each of the individual embodiments described and illustrated herein has discrete components and features which may be readily separated from or combined with the features of any other described embodiment(s) without departing from the scope of the present invention.

Any aspects described above in reference to apparatus may also apply to methods and vice versa.

Any recited method can be carried out in the order of events recited or in any other order which is logically possible. For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, simultaneously or at different times.

Various features are described herein as being present in “some embodiments”. Such features are not mandatory and may not be present in all embodiments. Embodiments of the invention may include zero, any one or any combination of two or more of such features. All possible combinations of such features are contemplated by this disclosure even where such features are shown in different drawings and/or described in different sections or paragraphs. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible). This is the case even if features A and B are illustrated in different drawings and/or mentioned in different paragraphs, sections or sentences.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

1-30. (canceled)

31. A method for steering light for a projector comprising:
illuminating an active surface of a light steering module, the active surface of the light steering module comprising a plurality of individually controllable pixels;
dividing the active surface into a plurality of regions, each region comprising a corresponding subset of the plurality of individually controllable pixels;
determining phase patterns for the plurality of regions of the active surface of the light steering module,
wherein each of the phase patterns is determined according to efficiency for steering of light to each of positions of output light field in a target plane.

32. The method of claim 31, wherein each of the phase patterns is determined according to a corresponding steering target, each of the steering targets being determined according to the efficiency for steering of light to each of the positions of the output light field in the target plane.

33. The method of claim 32, wherein the output light field to each of the positions in the target plane is a sum of light contributions from all of the regions.

34. The method of claim 31, wherein determining the phase pattern for each region comprises performing an iterative optimization for refining allocation of light contributions from all of the regions.

35. The method of claim 31, wherein the phase patterns for the plurality of regions are determined such that majority of each region are configured to contribute light to the target light field using a smaller steering angle.

36. The method of claim 31, wherein determining the phase pattern for each region comprises optimizing an objective function, wherein, for each region, attributing relatively high cost to the phase patterns where steering angle required to steer the light from the region is relatively large and relatively low cost to the phase patterns for where the steering angle required to steer the light from the region is relatively small.

37. The method of claim 31, wherein determining the phase pattern for each region comprises performing an optimization, wherein performing the optimization comprises estimating an actual light field output from the light steering module when particular phase patterns are applied to respective regions of the light steering module.

38. The method of claim 37, wherein the actual light field is estimated based on:
$$B ( x , y ) = {\sum }_{b = 1}^{b = N} {S}_{b} ( x , y ) {P}_{b} ( x , y )$$
wherein x and y represent a location in the light field, B(x,y) is the estimated actual light field, b is an index that runs over all N regions, S_{b}(x,y) represents steering efficiency of region b for steering light to point (x, y) in the actual light field and P_{b}(x,y) is a predicted contribution to the actual light field from region b without correction for steering efficiency.

39. The method claim 31, wherein determining the phase pattern for each region comprises performing an optimization, wherein performing the optimization comprises compensating for one or more defocusing effects associated with the projector using one or more point spread functions (PSFs).

40. The method of claim 31, wherein determining the phase pattern for each region comprises performing an optimization, wherein performing the optimization comprises estimating a deconvolved actual light field output from the light steering module when particular phase patterns are applied to respective regions of the light steering module.

41. The method of claim 40, wherein the deconvolved actual output light field R(x,y) is determined based on:
$$R ( x , y ) = {\sum }_{b = 1}^{b = N} {S}_{b} ( x , y ) {T}_{b} ( x , y )$$
wherein x and y represent a position in the deconvolved actual output light field, b is an index that runs over all N regions, S_{b}(x,y) represents steering efficiency of region b for steering light to point (x, y) in the deconvolved actual output light field and T_{b}(x,y) represents a deconvolved steering target for a region b.

42. The method of claim 41, wherein T_{b}(x,y) is determined based on:
$${T}_{b} ( x , y ) = \frac{{K}_{b} {S}_{b}^{β - 1} ( x , y )}{{\sum }_{a} {K}_{a} {S}_{a}^{β} ( x , y )} R ( x , y )$$
wherein: a is an index over the N regions; K₁, K₂, . . . , K_{N} are constants to be determined by the optimization; and wherein β is an exponent parameter ≥1.

43. The method of claim 31, further comprising providing each region with uniform intensity of incident light, and/or adjusting incident light provided to each region based on availability of incident light to generate a desired output light field.

44. A light steering projector comprising:
a light steering module having an active surface, the active surface of the light steering module comprising a plurality of individually controllable pixels;
at least one spatial light modulator configured to spatially modulate light from the light steering module;
a projector system configured to project the spatially modulated light; and
a controller, the controller configured to:
divide the active surface into a plurality of distinct regions, each region comprising a corresponding subset of the plurality of individually controllable pixels; and
determining phase patterns for the plurality of regions of the active surface of the light steering module;
wherein each of the phase patterns is determined according to efficiency for steering of light to each of positions of output light field in a target plane.

45. The light steering projector of claim 44, wherein each of the phase patterns is determined according to a corresponding steering target, each of the steering targets being determined according to the efficiency for steering of light to each of the positions of the output light field in the target plane.

46. The light steering projector of claim 45, wherein the output light field to each of the positions in the target plane is a sum of light contributions from all of the regions.

47. The light steering projector of claim 44, wherein the phase patterns for the plurality of regions are determined such that majority of each region are configured to contribute light to the target light field using a smaller steering angle to steer the light from the region.

48. The light steering projector of claim 44, wherein determining the phase pattern for each region comprises optimizing an objective function, wherein, for each region, attributing relatively high cost to the phase patterns where steering angle required to steer the light from the region is relatively large and relatively low cost to the phase patterns for where the steering angle required to steer the light from the region is relatively small.

49. The light steering projector of claim 44, wherein determining the phase pattern for each region comprises performing an optimization, wherein performing the optimization comprises estimating an actual light field output from the light steering module when particular phase patterns are applied to respective regions of the light steering module.

50. The light steering projector of claim 44, wherein determining the phase pattern for each region comprises performing an optimization, wherein performing the optimization comprises estimating a deconvolved actual light field output from the light steering module when particular phase patterns are applied to respective regions of the light steering module.
